(19) United States
(12) Patent Application Publication
(10) Pub. No.: US 2015/0288798 A1
(43) Pub. Date: Oct. 8, 2015

(54) View-through application for texting

(71) Applicant: Robert Wightman, Dade City, FL (US)

(72) Inventor: Robert Wightman, Dade City, FL (US)

(21) Appl. No.: 14/676,717

(22) Filed: Apr. 1, 2015

Related U.S. Application Data
(60) Provisional application No. 61/974,105, filed on Apr. 2, 2014.

(51) Int. Cl. H04M 1/725; H04N 5/232; G06T 11/60; H04N 5/225

(52) U.S. Cl. CPC H04M 1/72552; H04N 5/2257; H04N 5/23293; G06T 11/60

(57) ABSTRACT

A view-through mobile application for texting allows a user to text on a mobile electronic device while simultaneously viewing the image in front of the user through the camera of the device. The user clicks a button on the device to activate the camera while texting. The device displays both the image and the text on the same window. As a result, the user is able to text and walk at the same time without looking away from the device.

### CROSS-REFERENCE TO RELATED APPLICATIONS

This application claims the benefit of U.S. Provisional Application No. 61/974,105, filed Apr. 2, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to mobile applications, and in particular to a view-through mobile application for texting. Many individuals who use smartphones and other mobile electronic devices are in the practice of sending and reading text messages while walking. Unfortunately, they can't see where they are going and tend to trip and fall over any obstacles or irregularities in their paths. If the mobile electronic device provides a camera on its rear surface, a solution to this problem is at hand. A view-through mobile application for texting, which enables the user to see the path ahead while sending and receiving text messages, would resolve the problem.

### SUMMARY OF THE INVENTION

Accordingly, the invention is directed to a view-through mobile application for texting. The application allows a user to text on a mobile electronic device while simultaneously viewing the image in front of the user through the camera of the device. The user clicks a button on the device to activate the camera while texting. The device displays both the image and the text on the same window. As a result, the user is able to text and walk at the same time without looking away from the device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side view of a mobile electronic device with the first exemplary embodiment installed, displaying the device 10, the camera 11, and the field of vision 12.

FIG. 2 is a front view of a mobile electronic device with the first exemplary embodiment installed, displaying the device 10, and the field of vision 12.

FIG. 3 is a front view of a mobile electronic device in a landscape orientation with the first exemplary embodiment installed, displaying the device 10, and the field of vision 12.

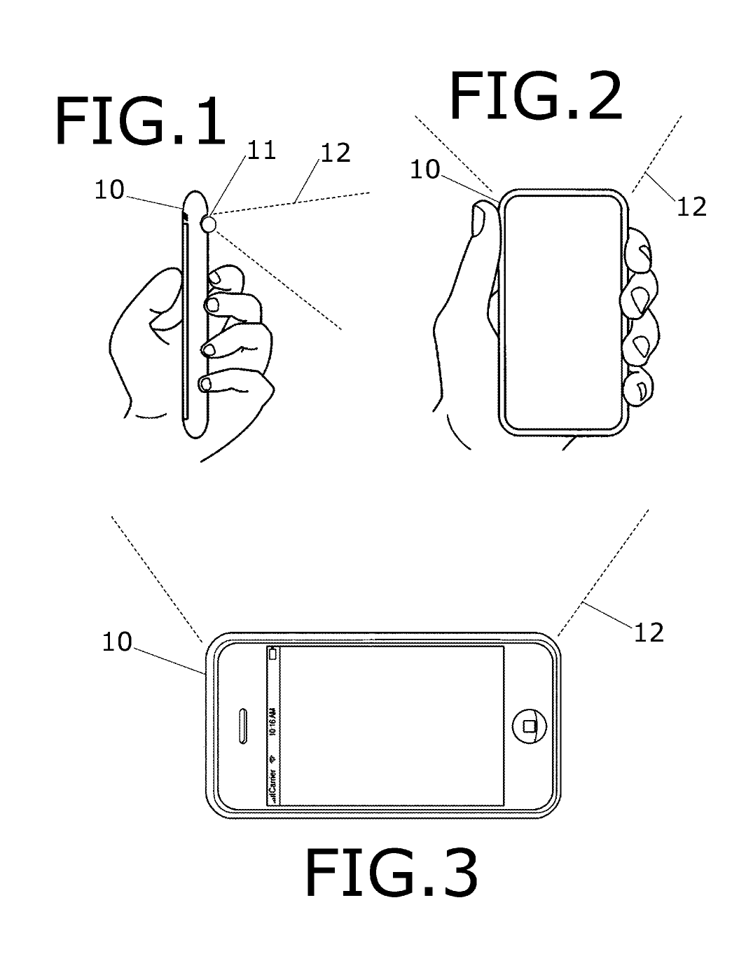

### DETAILED DESCRIPTION OF THE INVENTION

Referring now to the invention in more detail, the invention is directed to a view-through mobile application for texting on a mobile communication device such as a smartphone or tablet device. The application allows a user to text on a mobile electronic communication device 10 while simultaneously viewing a real time camera image in front of the user through the camera 11 of the device 10. The user clicks a button on the device 10 to activate the camera 11 while texting. ‘Texting’, as used herein, refers not only to the composing, reading, sending, and receiving of SMS messages, but also to email, world wide web browsing, and other applications; generically, the function of the mobile communication device 10 that supports texting activity is understood as a ‘texting application’. The device 10 displays both the image and the text on the same window. As a result, the user is able to text and walk at the same time without looking away from the device 10.

The first exemplary embodiment provides a mobile application, which may be used to provide a video view through the camera 11 of the mobile electronic device 10 where the application has been installed. The user may elect to use full screen transparency, or any one of a plurality of partial transparency levels. The user may also elect to use a portrait view for the field of vision 12, or rotate the device 10 by 90° to use a broader landscape view. The application may be turned on or off by using a button on the device 10, or the user may elect to maintain the application in an always-on state by using the application as wallpaper. The application may be used with social media websites and applications, and may be activated and deactivated by the user or it may be constantly active.

Features and functions listed above are preferable, but artisans will recognize that alternate features and functions could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system for providing a view-through mobile application, the system comprising a mobile communication device; said mobile communication being equipped with an outward facing camera; said outward facing camera having a field of view; and said mobile communication device being configured for:
(a) displaying a real time camera image;
(b) said real time camera image being displayed simultaneously with a texting application.
